(19) United States
(12) Patent Application Publication
(10) Pub. No.: US 2026/0030819 A1
(43) Pub. Date: Jan. 29, 2026

(54) CONE BEAM ARTIFACT REDUCTION

(71) Applicant: KONINKLIJKE PHILIPS N.V., EINDHOVEN (NL)

(72) Inventors: ARTYOM TSANDA, MOSCOW (RU); SEBASTIAN WILD, BAD OLDESLOE (DE); THOMAS KOEHLER, NORDERSTEDT (DE); MICHAEL GRASS, BUCHHOLZ IN DER NORDHEIDE (DE)

(21) Appl. No.: 18/881,467

(22) PCT Filed: Jul. 5, 2023
(86) PCT No.: PCT/EP2023/068473

§ 371 Date: Jan. 6, 2025

(30) Foreign Application Priority Data
Jul. 7, 2022 (RU) 2022118571

(51) Int. Cl. G06T 11/00

(52) U.S. Cl. CPC G06T 11/008; G06T 11/006; G06T 2211/421; G06T 2211/441; G06T 2211/448

(57) ABSTRACT

Systems and methods for training a machine-learning model for artifact reduction are provided. Such methods include retrieving a three-dimensional digital phantom reconstructed from CT imaging data. The method then selects a first Z position along the central axis and simulates a first set of forward projections from the digital phantom taken along an axial trajectory at the first Z position along the central axis. The first set of forward projections has a first simulated collimation in the axial direction. The method then reconstructs a first simulated image from the first set of forward projections and identifies a plurality of secondary Z positions along the central axis other than the first Z position. For each of the secondary Z positions and the first Z position itself, the method then simulates a set of secondary forward projections from the digital phantom taken along corresponding axial trajectories at the corresponding secondary Z position.

### FIELD

The present disclosure generally relates to systems and methods for training and using neural network models for reducing artifacts in cone-beam computed tomography (CT) images. In particular, the present disclosure relates to systems and methods for training and using 3D neural network models for correcting artifacts in the context of cone-beam derived CT images.

### BACKGROUND

Conventionally, in imaging modalities such as computed tomography, there are effects in the acquisition physics or reconstruction that lead to noise or artifacts in the final image. In order to train a denoising or artifact-reducing algorithm utilizing machine-learning, such as a neural network model, pairs of noisy and noiseless image samples, or artifact-prone and clean image samples, are typically presented to the neural network model, and the network attempts to minimize a cost function by denoising or removing artifacts from the sample noisy or artifact-prone image to recover a corresponding clean ground truth image.

Noiseless images, or clean images, are difficult to obtain, as they typically require a high radiation dose in order to generate images of a high quality. Accordingly, pairs of images usable for training purposes may be difficult to obtain, particularly in a clinical setting. Further, certain types of image artifacts have a fairly large spatial extent and require large amounts of contextual data to classify and remove such artifacts.

Cone-beam computed tomography (CBCT), as one example, is an imaging category that plays an important and increasing role in clinical applications but suffers from significant artifacts. Artifacts associated with cone-beam CT imaging tend to take the form of large streaks which require image and model context to consistently identify and correct.

These cone-beam artifacts appear due to data insufficiency inherent in an axial data acquisition and get more pronounced with increasing coverage along the Z-axis direction. In modern CBCT, there is a trend towards increasing cone angle, which increases Z-axis coverage in a scan. This trend exacerbates the artifacts in such images and makes the problem of correcting such artifacts more challenging.

There have been many methods proposed to address the issue. Apart from the ones requiring changes in hardware or changes in the data acquisition, several software-based approaches exist. For example, iterative reconstruction or second pass methods, which utilize computationally heavy forward- and back-projection, may be used.

There have been several approaches aiming to address CBCT artifacts correction using deep learning. However, such approaches rely on two dimensional neural networks or the implementation of a pseudo-3D network to three-dimensional data. Such approaches typically require substantial available data sets and/or are computationally heavy.

Accordingly, to address cone-beam artifacts using traditional methods, either hardware changes are required or the use of computationally heavy forward-and back-projection operations are implemented. Existing AI approaches do not address the problem with 3D neural networks. Instead, they either utilize 2D neural networks or apply pseudo-3D methods.

There is a need for a deep learning-based method that can be more easily trained and that can directly address cone beam artifacts using a 3D convolutional neural network (CNN). There is a further need for such a method that can be generalized across various CBCT cone angles as well as helical artifacts.

### SUMMARY

Systems and methods for training a machine-learning model for artifact reduction are provided. Such methods comprise first retrieving a three-dimensional digital phantom reconstructed from computed tomography (CT) imaging data. The CT imaging data comprises projection data acquired from a plurality of angles about a central axis. In some embodiments, the digital phantom is reconstructed from a helical scan.

The method then selects a first Z position along the central axis and simulates a first set of forward projections from the digital phantom taken along an axial trajectory at the first Z position along the central axis. The first set of forward projections has a first simulated collimation in the axial direction.

The method then reconstructs a first simulated image from the first set of forward projections. The first simulated image comprises a three-dimensional volume encompassing a first segment of the central axis including the first Z position. The method then identifies a first plurality of secondary Z positions along the central axis, other than the first Z position within the first segment of the central axis.

For each of the first plurality of secondary Z positions and the first Z position itself, the method then simulates a first set of secondary forward projections from the digital phantom taken along corresponding axial trajectories at the corresponding secondary Z position. The first set of secondary forward projections has a second simulated collimation in the axial direction smaller than the first simulated collimation.

The method then reconstructs the forward projections associated with each of the first plurality of secondary Z positions and the first Z position into a two-dimensional image corresponding to an axial slice of the digital phantom at the corresponding Z position along the central axis.

The method then combines the two-dimensional images associated with each of the first plurality of secondary Z positions and the first Z position to create a second simulated image comprising a three-dimensional volume corresponding to the three-dimensional volume of the first simulated image.

The method then proceeds to train a machine-learning algorithm by providing the first simulated image as a sample artifact-prone image and providing the second simulated image as ground truth. The machine-learning algorithm may be a three-dimensional convolutional neural network (CNN).

In some embodiments, the first segment of the central axis is centered on the first Z position.

The first simulated image may be reconstructed using a three-dimensional filtered back projection process, and the two-dimensional images corresponding to axial slices of the digital phantom may each be reconstructed using a two-dimensional filtered back projection process.

In some embodiments, each of the first simulated image and the second simulated image may be split into three-dimensional patches. Each patch of the first simulated image may then have a corresponding patch of the second simulated image, and the corresponding patches may be provided to the machine learning algorithm.

In some embodiments, the machine-learning algorithm comprises at least one first convolutional step applied to each patch of the first simulated image provided followed by at least one down-sampling operation. At least one additional convolutional step may then be applied after down-sampling, and the down-sampled patch may then be up-sampled after the at least one additional convolutional step. The up-sampled patch may then be concatenated with an output of the first convolutional step. In such an embodiment, the machine-learning algorithm may be structured as a three-dimensional U-net model, and each patch of the first simulated image may then be provided to the U-net model, and the output may then be compared to the corresponding patch of the second simulated image.

In some such embodiments, a forward pass through the U-net model may comprise conversion of data to half precision, and a following backward pass through the U-net model may comprise loss scaling in half precision.

In some embodiments, a mean square error between the output of the U-net model and the corresponding patch of the second simulated image may be defined as a loss function for training the machine-learning algorithm.

In some embodiments, prior to splitting the first simulated image into patches, the data corresponding to the first simulated image is normalized according to a sample mean and standard deviation calculated across a plurality of corrupted scans.

In some embodiments, the first simulated image and the second simulated image each comprise discrete photo, scatter, and combined image layers. In such embodiments, each three-dimensional patch of the first simulated image and the second simulated image may then comprise corresponding discrete photo, scatter, and combined image layers, each provided to the machine-learning algorithm as discrete channels. Each image layer is then processed with a discrete loss function, and each channel is normalized independently of the other channels.

In some embodiments, each patch further comprises positional encoding, such that the machine-learning algorithm is provided with positional data associated with the corresponding patch.

In some embodiments, the method further includes incorporating an artifact causing feature into the three-dimensional digital phantom prior to selecting the first Z position.

In some embodiments, the method proceeds to generate additional training images from the digital phantom. In such embodiments, the method may proceed to select a second Z position along the central axis of the digital phantom and simulate a second set of forward projections from the digital phantom taken along an axial trajectory at the second Z position along the central axis. The second set of forward projections have the first simulated collimation.

The method then proceeds to reconstruct a third simulated image from the second set of forward projections. The third simulated image is a three-dimensional volume encompassing a second segment of the central axis including the second Z position and different than the first segment of the central axis.

The method then identifies a second plurality of secondary Z positions along the central axis other than the second Z position within the second segment of the central axis and for each of the second plurality of secondary Z positions and the second Z position, simulates a second set of secondary forward projections from the digital phantom taken along an axial trajectory at the corresponding secondary Z position. The second set of secondary forward projections have the second simulated collimation.

The method then proceeds to reconstruct the forward projections associated with each of the second plurality of secondary Z positions and the second Z position into a two-dimensional image corresponding to an axial slice of the digital phantom at the corresponding Z position along the central axis.

The method then combines the two-dimensional images to create a fourth simulated image comprising a three-dimensional volume corresponding to the three-dimensional volume of the third simulated image.

The method then continues to train the machine-learning algorithm by providing the third simulated image as a sample artifact-prone image and providing the fourth simulated image as ground truth.

In some such embodiments, the first, second, third, and fourth simulated images are all provided to the machine-learning algorithm as a batch.

In some embodiments, the three-dimensional digital phantom varies along a time dimension. The first simulated image and the second simulated image are then drawn from the digital phantom at a first time along the time dimension, and the method proceeds to simulate a second set of forward projections from the digital phantom at a second time along the time dimension taken along an axial trajectory at the first Z position. The second set of forward projections has the first simulated collimation.

The method then reconstructs a third simulated image from the second set of forward projections, the third simulated image being a three-dimensional volume corresponding to the three-dimensional volume of the first simulated image.

For each of the first plurality of secondary Z positions and the first Z position, the method then simulates a second set of secondary forward projections from the digital phantom at the second time along the time dimension taken along an axial trajectory at the corresponding secondary Z position. The second set of secondary forward projections each have the second simulated collimation.

The method then reconstructs the forward projections associated with each of the first plurality of secondary Z positions and the first Z position into a two-dimensional image corresponding to an axial slice of the digital phantom at the corresponding Z position along the central axis and combines the two-dimensional images to create a fourth simulated image comprising a three-dimensional volume corresponding to the three-dimensional volume of the first simulated image.

The method then continues to train the machine-learning algorithm by providing the third simulated image as a sample artifact-prone image and providing the fourth simulated image as ground truth.

In some embodiments, the method proceeds to implement an artifact reduction method. In such an embodiment, the method retrieves cone-beam CT imaging data acquired using a cone-beam computed tomography process. The method then applies the trained machine-learning algorithm to the cone-beam CT imaging data and generates an artifact reduced image comprising a three-dimensional volume.

### BRIEF DESCRIPTION OF THE DRAWINGS

FIG. 1 is a schematic diagram of a system according to one embodiment of the present disclosure.

FIG. 2 illustrates an exemplary imaging device according to one embodiment of the present disclosure.

FIG. 3 illustrates a method for generating a training set to train a model for artifact reduction in images in accordance with the present disclosure.

FIG. 4 illustrates a schematic pipeline for training a model used for artifact reduction in images in accordance with the present disclosure.

FIG. 5 is a flow chart illustrating a method for artifact reduction in accordance with this disclosure.

FIG. 6 illustrates an alternate schematic pipeline for training a model used for artifact reduction in images in accordance with the present disclosure.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features: the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

Generally, images acquired for use in a medical setting require some processing in order to denoise or remove artifacts from the images. Such artifact removal is necessary in the medical setting, where images are likely to be used for diagnoses and treatment, as precision and accuracy in such images can improve their usability. Such artifact removal may be implemented using machine learning based algorithms, such as convolutional neural networks (CNNs).

In the context of cone-beam computed tomography (CBCT) imaging, imaging artifacts are often fairly large and require model context for artifact reduction. For example, artifacts may take the form of streaks across sections of an image. Further, cone-beam artifacts may be due to data insufficiency inherent in an axial data acquisition. In some cases, cone-beam images may be derived from as little as one axial rotation of a radiation source around a subject. Accordingly, while some artifact reduction may be accomplished by filtering raw data or finalized images, CBCT artifact reduction may require a more nuanced approach that accounts for such data insufficiency.

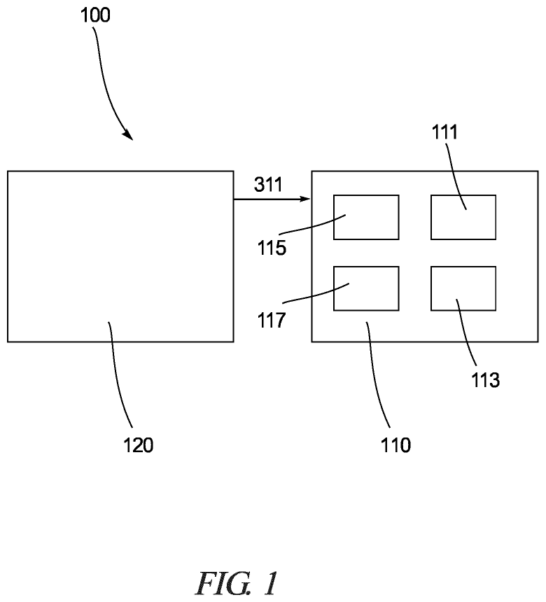

FIG. 1 is a schematic diagram of a system 100 according to one embodiment of the present disclosure. As shown, the system 100 typically includes a processing device 110 and an imaging device 120.

The processing device 110 may apply processing routines to images or measured data, such as projection data, received from the image device 120. The processing device 110 may include a memory 113 and processor circuitry 111. The memory 113 may store a plurality of instructions. The processor circuitry 111 may couple to the memory 113 and may be configured to execute the instructions. The instructions stored in the memory 113 may comprise processing routines, as well as data associated with processing routines, such as machine learning algorithms, and various filters for processing images.

The processing device 110 may further include an input 115 and an output 117. The input 115 may receive information, such as images or measured data, from the imaging device 120. The output 117 may output information, such as filtered images, to a user or a user interface device. The output may include a monitor or display.

In some embodiments, the processing device 110 may relate to the imaging device 120 directly. In alternate embodiments, the processing device 110 may be distinct from the imaging device 120, such that the processing device 110 receives images or measured data for processing by way of a network or other interface at the input 115.

In some embodiments, the imaging device 120 may include an image data processing device, and a spectral or conventional CT scanning unit for generating CT projection data when scanning an object (e.g., a patient). In some embodiments, the imaging device 120 may be a conventional CT scanning unit configured for generating helical scans for use in the generation of training data, as discussed below. In some embodiments, the imaging device 120 may be a cone-beam CT unit configured for obtaining a cone-beam image from a single axial scan of a subject.

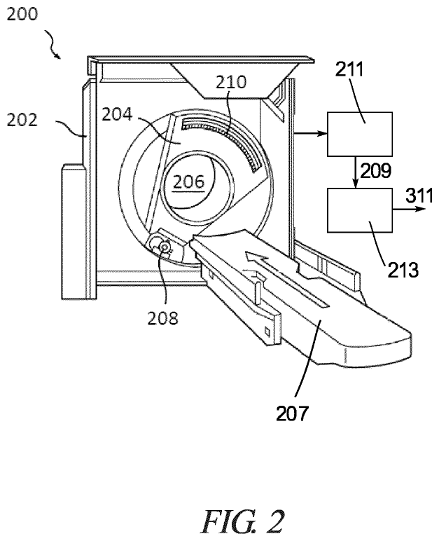

FIG. 2 illustrates an exemplary imaging device 200 according to one embodiment of the present disclosure. It will be understood that while a CT imaging device is shown, and the following discussion is generally in the context of CT images, similar methods may be applied in the context of other imaging devices, and images to which these methods may be applied may be acquired in a wide variety of ways.

In an imaging device 200 in accordance with embodiments of the present disclosure, the CT scanning unit may be adapted for performing one or multiple axial scans and/or a helical scan of an object in order to generate the CT projection data. In an imaging device 200 in accordance with embodiments of the present disclosure, the CT scanning unit may comprise an energy-resolving photon counting or spectral dual-layer image detector. Spectral content may be acquired using other detector setups as well. The CT scanning unit may include a radiation source that emits radiation for traversing the object when acquiring the projection data.

In the example shown in FIG. 2, the CT scanning unit 200, e.g. the Computed Tomography (CT) scanner, may include a stationary gantry 202 and a rotating gantry 204, which may be rotatably supported by the stationary gantry 202. The rotating gantry 204 may rotate about a longitudinal axis around an examination region 206 for the object when acquiring the projection data. The CT scanning unit 200 may include a support 207 to support the patient in the examination region 206 and configured to pass the patient through the examination region during the imaging process.

The CT scanning unit 200 may include a radiation source 208, such as an X-ray tube, which may be supported by and configured to rotate with the rotating gantry 204. The radiation source 208 may include an anode and a cathode. A source voltage applied across the anode and the cathode may accelerate electrons from the cathode to the anode. The electron flow may provide a current flow from the cathode to the anode, such as to produce radiation for traversing the examination region 206.

The CT scanning unit 200 may comprise a detector 210. The detector 210 may subtend an angular arc opposite the examination region 206 relative to the radiation source 208. The detector 210 may include a one-or two-dimensional array of pixels, such as direct conversion detector pixels. The detector 210 may be adapted for detecting radiation traversing the examination region 206 and for generating a signal indicative of an energy thereof.

Generally, the CT scanning unit acquires a sequence of projection frames as the rotating gantry 204 rotates about the patient. Accordingly, depending on the amount of gantry movement between frames, each acquired frame of projection data overlaps to some extent with adjacent frames, and consists of imaging data of the same subject, i.e., the patient, acquired at a different angle.

The CT scanning unit 200 may include generators 211 and 213. The generator 211 may generate tomographic projection data 209 based on the signal from the detector 210. The generator 213 may receive the tomographic projection data 209 and, in some embodiments, generate a sequence of raw image data frames 311 of the object based on the tomographic projection data 209. In some embodiments, the tomographic projection data 209 may be provided to the input 115 of the processing device 110, while in other embodiments the sequence of raw image data frames 311 is provided to the input of the processing device.

In some embodiments, a first CT scanning unit 200 may be used during training of the models for artifact reduction described below while a second CT scanning unit 200 may be used for acquiring imaging data for which artifact reduction is required. For example, the first CT scanning unit 200 may be used for acquiring imaging data for use in creating a three-dimensional digital phantom for use in training. Such imaging data may be acquired by way of a helical scan from the first CT scanning unit 200. In contrast, the second CT scanning unit 200 may be a cone-beam CT unit configured to acquire imaging data that requires artifact reduction.

Accordingly, the first CT scanning unit 200 may be provided with a one- or two-dimensional array of pixels in a detector 210, and the traditional axial or helical scan process may generate two dimensional projections. In contrast, the second CT scanning unit 200 may be provided with a two-dimensional array of pixels in the corresponding detector 210, and the unit may then implement a cone-beam image acquisition process. In some embodiments, the cone-beam image acquisition process includes only a single axial scan comprising a set of projections taken along an axial trajectory about an axis of the subject, typically corresponding to the longitudinal axis of the examination region 206.

In some embodiments, the size of the array of pixels in the detector 210 defines a collimation size of the image data acquired through that array. Accordingly, a one-dimensional array of pixels may only be used to acquire a two-dimensional projection taken in the axial direction, while a two-dimensional array of pixels may be used to acquire a three-dimensional projection having some collimation size in an axial direction. A CT scanning unit 200 configured for acquiring cone-beam CT images may have a larger, or wider, two-dimensional array of pixels and may thereby provide for a larger collimation in the axial direction.

In the method described herein, a first step is typically to acquire training data and to then train a machine-learning model for artifact-reduction. As discussed below, the method provides for training a three-dimensional neural network to reduce artifacts typical in the context of cone-beam computed tomography (CBCT). In order to support the training of such a model, the method first requires a dataset including registered pairs of corrupted and clean images that can then be used for such training.

In a clinical setting, registered pairs of corrupted and clean images are not easily available. Clean images usable as ground truth typically require a full dosage of radiation, while the acquisition of registered pairs typically requires multiple scans, where one of the scans is taken with a full dosage of radiation using a traditional modality, such as standard axial or helical scanning, and a second scan is taken using the modality for which artifact reduction is sought. Further, even where two real scans are taken, such scans are not easily relatable to each other, since locations may be offset from each other and a resolution mismatch may exist between the paired images. In addition, for anatomies with complex motion patterns, such as the heart or the lung, the registration between two scans would also involve a non-rigid deformation corresponding to the different cardiac or breathing states associated with the two scans. In practice, it is often hard or impossible to achieve registered pairs of images with the accuracy necessary for use as training data in a neural network.

Accordingly, in some embodiments, the method begins by generating a simulated dataset.

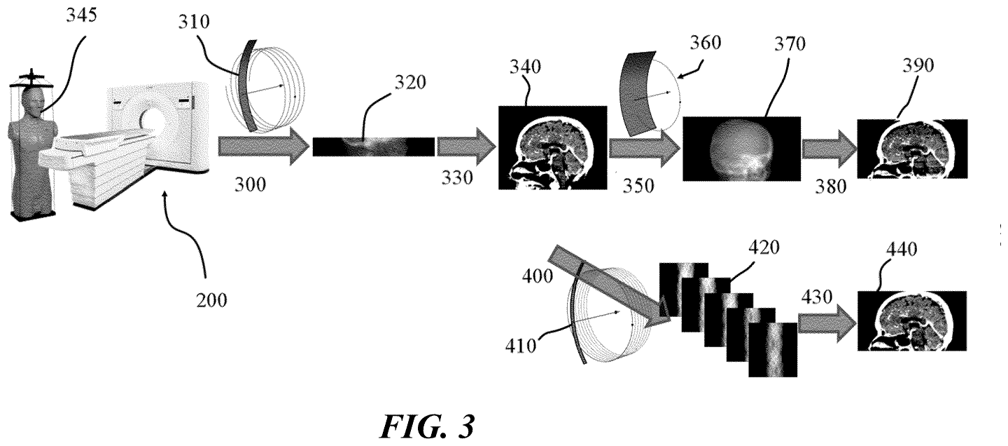

FIG. 3 illustrates a method for generating a training set to train a model for artifact reduction in images in accordance with the present disclosure. As shown, the method may begin by scanning a patient using a CT scanning unit 200 by way of a traditional modality (at 300). Accordingly, a traditional detector 210 with either a one-dimensional or two-dimensional sensor array 310 may be provided and may then be used to implement a helical acquisition (300). The projections 320 acquired using the helical acquisition process (300) may then be reconstructed (330) using a traditional methodology in order to generate a three-dimensional digital phantom 340.

A digital phantom 340 is a three-dimensional digital model usable for simulating imaging processes. Such a digital phantom in this case is a three-dimensional image or model reconstructed from a traditional scan and may be a helical image. The digital phantom may then be used to simulate distinct methodologies for imaging scans.

While the method described herein starts with a scan of a patient using a CT scanning unit 200 (at 300), such a scan could similarly be replaced by a simulated scan of an existing digital phantom drawn from a database or a scan of a physical phantom 345, or human model. Accordingly, the scan of the physical phantom 345 or simulated scan (at 300) could then be used to simulate a helical acquisition (310) of a human subject such that the resulting digital phantom 340 takes the form expected for the training of the machine-leaning model.

In some embodiments, no such conversion is necessary, and the digital phantom 340 usable for training is itself drawn from a database. Any such digital phantom 340 would have been created originally from imaging data, and such imaging data would have initially comprised projection data acquired form a plurality of angles about a central axis of the corresponding subject.

The digital phantom 340 is generally assumed to be a complete model of the subject being used for training, and may be used to generate clean images without noise or artifacts and usable as ground truth. Alternatively, the digital phantom 340 may be used to simulate an imaging modality known to introduce artifacts.

Accordingly, as shown, the digital phantom 340 is used to simulate an axial acquisition at a specified Z position along the central axis of a subject. Such an axial acquisition may comprise a single axial rotation, and may then comprise simulating a first set of forward projections 370 from the digital phantom 340 taken along an axial trajectory at the first Z position (350).

The first set of forward projections 370 have a first simulated collimation 360 in the axial direction. The first simulated collimation 360 may be based on a simulated two-dimensional array of pixels corresponding to a detector usable for cone beam CT imaging. Accordingly, the first simulated collimation 360 may be larger in the axial direction than would be expected in traditional axial or helical CT imaging, but may instead correspond to collimation expected in the context of cone-beam CT image acquisition. For example, the first simulated collimation 360 may be a 16 cm axial simulation.

The first set of forward projections 370 may then be used to reconstruct (380) a first simulated image 390. Such reconstruction may be, for example, by way of standard filtered back-projection performed in three-dimensions. The first simulated image 390 may then comprise a three-dimensional volume encompassing a first segment of the central axis including the first Z position, and may thereby contain artifacts typical of cone-beam CT acquisitions.

The digital phantom 340 may then be used separately to simulate a traditional axial scan. Accordingly, the method may identify a plurality of secondary Z positions along the central axis other than the first Z position within the first segment of the central axis and may then simulate a slice-by-slice scan (400) of the digital phantom 340. This would then result in a first set of secondary forward projections 410 each taken along corresponding axial trajectories at corresponding Z positions.

The slice-by-slice scan (at 400) would have a second simulated collimation in the axial direction smaller than the first simulated collimation. In some embodiments, the second simulated collimation is based on a simulated one-dimensional array of pixels 410 in a detector. In such an embodiment, each slice would comprise a one-dimensional projection 420.

The forward projections 420 associated with each Z position are then reconstructed (430) into corresponding two-dimensional images corresponding to axial slices of the digital phantom at the corresponding Z position along the central axis. Such reconstruction is repeated for the forward projections 420 associated with each secondary Z position as well as that associated with the first Z position.

The reconstructed two-dimensional images associated with each of the Z positions are then combined along the Z direction, resulting in a three-dimensional second simulated image 440. The second simulated image 440 has a geometry identical to the first simulated image 390. However, while the first simulated image 390 has artifacts associated with cone-beam CT image acquisition, the second simulated image 440 is based on two-dimensional image reconstruction within the plane of axial acquisition and therefore has no such artifacts. This is because, if compared to the cone-beam acquisition process, the second simulated image 440 would have an effective cone-angle of zero, thereby removing the problem of data insufficiency of an axial scan.

Accordingly, the second simulated image 440 may be used as a ground truth image for network training, while the network is trained to remove artifacts from the first simulated image 390.

In some embodiments, the digital phantom 340 or helical scan 300 discussed above may directly be used as ground truth. However, by using the second simulated image 440, there is no resolution mismatch between the first simulated image 390 and the ground truth, as both have undergone one iteration of forward and back projection. In this way, a neural network trained on such an image pair will focus on the task of removing cone-beam artifacts, and will not be dominated by correcting resolution mismatch.

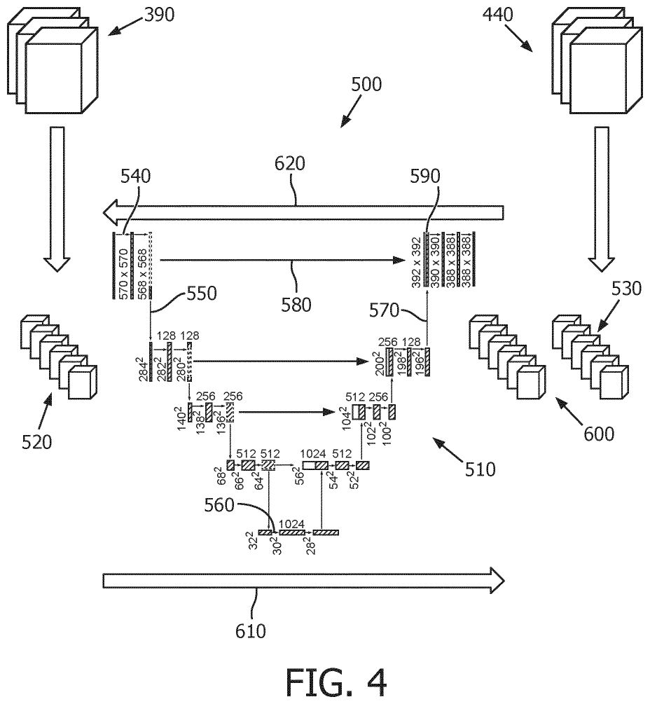

FIG. 4 illustrates a schematic pipeline 500 for training a model used for artifact reduction in images in accordance with the present disclosure. As shown, the machine-learning algorithm may be a three-dimensional convolutional neural network (CNN) 510 implemented using a U-net like architecture.

In training the CNN 510, the method may begin with a set of corrupted scans, such as the first simulated image 390 discussed above and a set of corresponding ground truth scans of the same subject, such as the second simulated image 440 discussed above. In order to implement the three-dimensional CNN 510, a method, discussed in more detail below, must first split each three-dimensional image 390, 440 into corresponding patches 520 from the corrupted first simulated image 390 and corresponding patches 530 from the second simulated image 440 used as ground truth.

For ease of understanding, the method is described here and below in terms of a single pair of a first simulated image 390 and a second simulated image 440. However, it will be understood that the CNN 510 is trained on a large number of indexed pairs of images. Such pairs of images may be generated from a single digital phantom 340 by selecting different Z positions as starting points, as well as from multiple digital phantoms containing different content.

Once paired corresponding patches 520, 530 are provided to the CNN 510, each corrupted patch 520 is provided to the network 510. Where the CNN 510 has a U-net or similar architecture, as shown, the machine-learning algorithm includes at least one first convolutional step 540 applied to each patch followed by at least one down-sampling operation 550. After down-sampling 550 at least one additional convolutional step 560 is implemented followed by up-sampling 570.

After both down-sampling 550 and up-sampling steps 570 and an intervening convolutional step 560, the output of the first convolutional step 540 is concatenated 580 with an up-sampled patch 590. As shown, the down-sampling 550 and up-sampling 570 may be repeated several times with additional convolutions being implemented between each level. In some embodiments, the concatenations described are implemented at each level, such that the CNN 510 functions symmetrically.

The resulting output is a prediction 600 corresponding to each corrupted patch 520 which can then be compared to the corresponding patch 530 of the ground truth simulated image 440. The CNN 510 may then be trained by evaluating the success with which the prediction 600 corresponds to the patch 530 of the simulated image 440 in terms of a loss function, such as a calculation of mean square error between the two.

The CNN 510 may be implemented both forwards 610 and backwards 620, and may be repeated with pairs of images until results converge and the loss function is minimized. The backwards pass 620 may be, for example, a backpropagation of an output of a loss function, so as to increase the precision of variable weights in the model. Accordingly, after each pass, weights within the CNN 510 may be updated prior to further training.

Various techniques are implemented in order to reduce the memory usage of the CNN 510 during implementation. As discussed above, the CNN 510 is provided with three-dimensional patches 520, 530 instead of the full simulated images 390, 440 from which they are drawn. This approach avoids the need to store the entire CT volume is GPU memory. Further, mixed precision training may be implemented, such that the forward 610 and backward 620 passes use half-precision floating point numbers, and thereby utilize 16 bits instead of 32 bits. Similarly, the use of the U-net architecture itself reduces the need for memory because feature maps are down-sampled during processing and take up less memory.

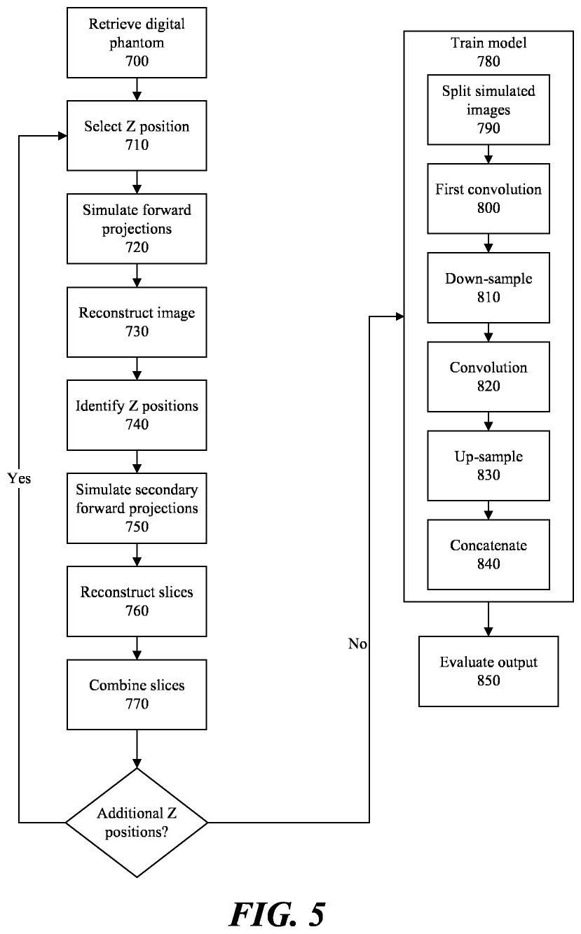

FIG. 5 is a flow chart illustrating a method for artifact reduction in accordance with this disclosure. As discussed above with respect to FIG. 3, the method first generates paired simulated images 390, 440 for use in a training set. Accordingly, the method first retrieves (700) a three-dimensional digital phantom 340 for use in generating the paired images. The three-dimensional digital phantom 340 is typically reconstructed from computed tomography (CT) data previously acquired. That CT data comprises projection data acquired from a plurality of angles about a central axis. As noted above, the digital phantom 340 may be constructed from a helical scan 300.

In some embodiments, the method may be utilized to address potential artifacts generated by discrete objects or features in an image known to cause artifacts. For example, the method may be utilized to address artifacts generated by external objects, such as metal implants. Accordingly, prior to generating the simulated images, an artifact causing feature, such as a simulated metal plate, may be incorporated into the three-dimensional digital phantom 340 prior to proceeding. Similarly, motion may be simulated during the creation of the simulated images 390, 440.

The method then selects (710) a first Z position along the central axis and simulates (720) a first set of forward projections from the digital phantom 340 taken along an axial trajectory at the first Z position. The first set of forward projections has a first simulated collimation in the axial direction.

In some embodiments, the first set of forward projections are for simulating a cone-beam CT process. As such, the first simulated collimation may be fairly large, and may be, for example, 16 cm. Further, the forward projections may be acquired in a single simulated pass along an axial trajectory about the digital phantom 340 at the first Z position. Accordingly, the data acquired in the first set of forward projections is limited.

The method then proceeds by reconstructing (730) the first simulated image 390 from the first set of forward projections. The reconstruction (at 730) may be implemented using a three-dimensional filtered back projection process. The first simulated image 390 comprises a three-dimensional volume encompassing a first segment of the central axis including the first Z position. In some embodiments, the first segment of the central axis is centered on the first Z position.

The method then proceeds by identifying (740) a first plurality of secondary Z positions along the central axis other than the first Z position that are within the first segment of the central axis. For each of the first plurality of secondary Z positions and the first Z position, a first set of secondary forward projections are simulated (750) from the digital phantom. Each first set of secondary forward projections is taken along a corresponding axial trajectory at the corresponding secondary Z position. Each set of secondary forward projections taken in this way has a second simulated collimation in the axial direction smaller than the first simulated collimation.

In this way, each first set of secondary forward projections corresponds to an axial slice of the digital phantom 340 having a thickness smaller than the first simulated image 390. In some embodiments, each set of secondary forward projections is obtained using a simulation of a detector having a one-dimensional array of pixels. Accordingly, each slice generated by a set of secondary forward projections is two dimensional.

Following the acquisition of the secondary forward projections, the forward projections of each first set associated with a corresponding secondary Z position or the first Z position is reconstructed (760) into a two-dimensional image corresponding to an axial slice of the digital phantom at the corresponding Z position along the central axis. Each axial slice of the digital phantom 340 may be reconstructed using a two-dimensional filtered back projection process. The two-dimensional images are then combined (770) along the central axis to create the second simulated image 440 comprising a three-dimensional volume corresponding to the three-dimensional volume of the first simulated image.

The method then proceeds to train (780) a machine-learning algorithm, such as the three-dimensional CNN 510 discussed above, by providing the first simulated image 390 as a sample artifact-prone image and providing the second simulated image 440 as ground truth.

As noted above, the embodiment is described in terms of the generation of a single matched pair of images. However, in use, the matched pair of images created is one of many pairs of images in a sample utilized in training. In some embodiments, prior to proceeding by splitting (790) each image into patches, data corresponding to the first simulated image 390 may be normalized according to a sample mean and standard deviation calculated across a plurality of corrupted scans.

In some embodiments, multiple matched pairs of images may be generated from a single digital phantom 340. Accordingly, either following the generation of the first simulated image 390 and the second simulated image 440 (at 770), the method may then create additional paired images by selecting a second Z position different from the first Z position along the central axis of the digital phantom (at 710). The method then simulates (720) a second set of forward projections from the digital phantom 340 taken along an axial trajectory at the second Z position along the central axis. The second set of forward projections have the same first simulated collimation in the axial direction as the first set of forward projections.

The method then reconstructs (730) a third simulated image from the second set of forward projections. The third simulated image is a three-dimensional volume encompassing a second segment of the central axis including the second Z position and different than the first segment of the central axis.

The method then proceeds to identify (740) a second plurality of secondary Z positions along the central axis other than the second Z position within the second segment of the central axis. For each of the second plurality of secondary Z positions and the second Z position, the method then simulates (750) a second set of secondary forward projections from the digital phantom 340 taken along an axial trajectory at the corresponding secondary Z position. The second set of secondary forward projections has the second simulated collimation.

The method then reconstructs (760) the forward projections into two-dimensional images corresponding to a lateral slice of the digital phantom at the corresponding Z position along the central axis and combines (770) the two-dimensional images to create a fourth simulated image comprising a three-dimensional volume corresponding to the three-dimensional volume of the third simulated image.

In this way, the third simulated image may be formed in a manner similar to the first simulated image 390 by selecting a second Z position along the central axis different than the first Z position. The fourth simulated image may then be formed to pair with the third simulated image. Such a process may be repeated for additional Z positions in order to create a large data set from a limited number of or even a single digital phantom 340.

This approach of simulating cone-beam artifacts from a given three-dimensional volume allows the method to create perfectly registered pairs of corrupted and clean images. Selecting different Z positions during simulation allows for the augmentation of the data set size, since each Z position will produce slightly different artifacts.

In some embodiments, instead of, or in addition to, varying the Z position used to generate the first and third simulated images, a time dimension may be varied. In such an embodiment, the digital phantom 340 may vary along a time dimension. For example, the digital phantom may correspond to data from one or more CT scan taken across a period of time or taken at different time periods. Such an acquisition taken across time may be used to capture movement in a subject, and may be, for example, a gated cardiac scan. Accordingly, the three-dimensional digital phantom 340 may contain data from different time periods, and the digital phantom itself may thereby vary along a time dimension.

In such an embodiment, the first simulated image 390 and the second simulated image 440 may be drawn from the digital phantom at a first time along the time dimension. The method may then repeat the method of generating the first and second simulated images 390, 440 at a second time along the time dimension, thereby generating a third and fourth simulated image. As discussed above with respect to varying the Z position, this technique may be used to generate additional training data from a single digital phantom.

Once a training set is available, the method proceeds to train (780) the machine learning algorithm with the available dataset.

As discussed above, as part of the training process, the method may split (790) each of the first simulated image 390 and the second simulated image 440 into three-dimensional patches 520, 530. Accordingly, each patch 520 of the first simulated image 390 has a corresponding patch 530 of the second simulated image 440. In such a training process, the three-dimensional patches are provided to the machine-learning algorithm. In some embodiments, each patch 520, 530 includes positional encoding. For example, each voxel may be provided with a (Z, X, Y) position. Accordingly, the machine learning algorithm is provided with positional data associated with the corresponding patch. This may provide the model with information about the Z position of each patch, allowing for better control of the network's behavior.

The patches may be random and are significantly smaller than the images from which they are drawn. For example, the patches may be of size (64, 128, 128) out of images with size (256, 512, 512) corresponding (Z, X, Y) dimensions.

Further, as discussed above, the three-dimensional CNN may comprise at least one first convolutional step (800) applied to each patch 520 of the first simulated image 390 followed by at least one down-sampling operation (810). At least one additional convolutional step (820) is then applied after down-sampling, and the down-sampled patch is then up-sampled (830) after the at least one additional convolutional step. The up-sampled patch is then concatenated (840) with an output of the first convolutional step (at 800).

In some embodiments, the various down-sampling, up-sampling, and convolutional operations may be implemented in a three-dimensional U-net model, described and shown in more detail above with respect to FIG. 4. Accordingly, each patch 520 of the first simulated image 390 is provided to the three-dimensional U-net model and the output is compared (850) to the corresponding patch 530 of the second simulated image 440. The comparison may be based on a loss function for training the CNN, which may be defined as, for example, a mean square error between the output of the U-net model and the corresponding patch 530 of the second simulated image 440. The output of such a loss function may then be back propagated through the model in a backwards pass 620.

In some embodiments, as discussed above, a forward pass 610 through the U-net model comprises conversion of data to half precision and a following backwards pass 620 through the U-net model comprises loss scaling in half precision.

Following the training of the CNN 510, in some embodiments, the trained model may be used to reduce artifacts in an image. In such embodiments, the method may retrieve cone-beam computed tomography imaging data acquired using a cone-beam computed tomography process. The trained CNN 510 may then be applied to the cone-beam computed tomography imaging data in order to generate an artifact reduced image comprising a three-dimensional volume.

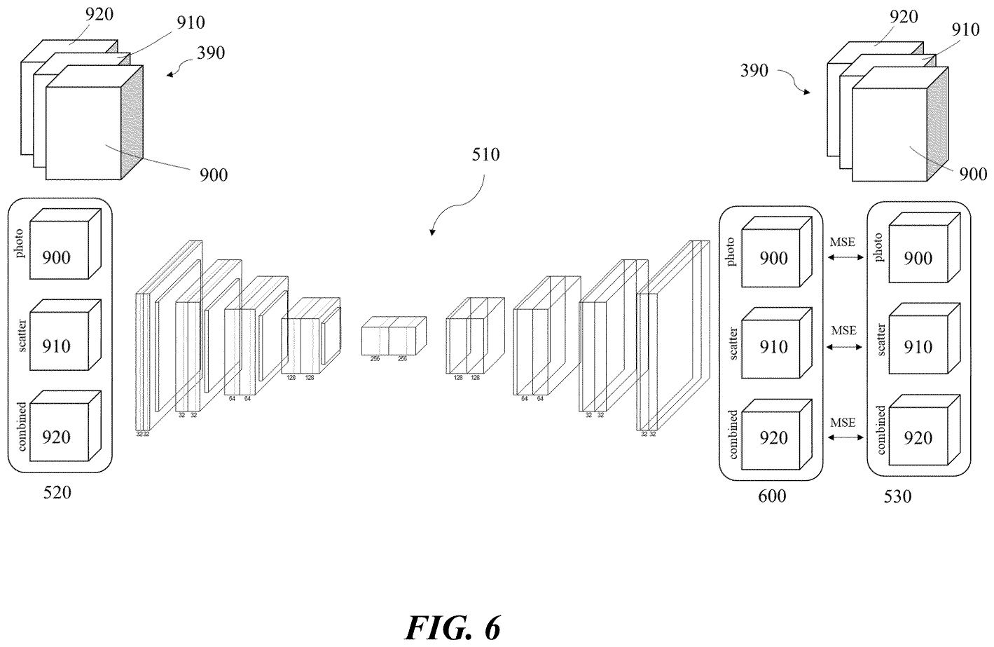

FIG. 6 illustrates an alternate schematic pipeline for training a model used for artifact reduction in images in accordance with the present disclosure.

In some embodiments, the first simulated image 390 and the second simulated image 440 each simulate spectral scans, and therefore each of the simulated images comprise discrete photo 900, scatter 910, and combined 920 image layers. Each three-dimensional patch 520 of the first simulated image 390 and each three three-dimensional patch 530 of the second simulated image 440 each similarly comprise corresponding discrete photo 900, scatter 910, and combined 920 image layers. Each layer of each patch is then provided to the CNN 510, shown in FIG. 6 in a simplified form, as a discrete channel in order to generate a corresponding predicted patch 600 layer, each of which is processed with a discrete loss function. In such an embodiment, each channel may be normalized independently of the other channels.

In some embodiments, the loss function is a sum of the mean square error values calculated for each channel. In such an embodiment it is important to balance performance between predictions. Accordingly, each channel may then have different normalization values. Instead of using sample mean and standard deviation in such an embodiment, the method may shift and scale data according to level and window values taken later for visualization. For example, if scatter is typically visualized with level −50 and window 400, then the method may shift data by −50 and scale by 200, which is a half of the window. This technique helps to evenly distribute performance of the model between different channels and achieve visually equal results.

The method discussed herein may be used to combine artifact reduction with denoising and/or super-resolution processing and other image-to-image problems. Accordingly, problems to be addressed should be simulated when creating the simulated images. For example, in order to combine artifact reduction with denoising, the simulation of the axial acquisition for the first simulated image 390 should be combined with a simulation of a low dose acquisition.

In some embodiments, three-dimensional natural images can be used for training the artifacts removal. Due to huge structure variability a model trained using natural images has all the prerequisites to be generalizable to the medical image domain.

The methods according to the present disclosure may be implemented on a computer as a computer implemented method, or in dedicated hardware, or in a combination of both. Executable code for a method according to the present disclosure may be stored on a computer program product. Examples of computer program products include memory devices, optical storage devices, integrated circuits, servers, online software, etc. Preferably, the computer program product may include non-transitory program code stored on a computer readable medium for performing a method according to the present disclosure when said program product is executed on a computer. In an embodiment, the computer program may include computer program code adapted to perform all the steps of a method according to the present disclosure when the computer program is run on a computer. The computer program may be embodied on a computer readable medium.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for training a machine-learning model for artifact-reduction, comprising:
retrieving a three-dimensional digital phantom reconstructed from computed tomography imaging data, the computed tomography imaging data comprising projection data acquired from a plurality of angles about a central axis;
selecting a first Z position along the central axis;
simulating a first set of forward projections from the digital phantom taken along an axial trajectory at the first Z position along the central axis, the first set of forward projections having a first simulated collimation in the axial direction;
reconstructing a first simulated image from the first set of forward projections, the first simulated image comprising a three-dimensional volume encompassing a first segment of the central axis including the first Z position;
identifying a first plurality of secondary Z positions along the central axis other than the first Z position within the first segment of the central axis;
for each of the first plurality of secondary Z positions and the first Z position, simulating a first set of secondary forward projections from the digital phantom taken along corresponding axial trajectories at the corresponding secondary Z position, the first set of secondary forward projections having a second simulated collimation in the axial direction smaller than the first simulated collimation;
reconstructing the forward projections associated with each of the first plurality of secondary Z positions and the first Z position into a two-dimensional image corresponding to an axial slice of the digital phantom at the corresponding Z position along the central axis;
combining the two-dimensional images associated with each of the first plurality of secondary Z positions and the first Z position to create a second simulated image comprising a three-dimensional volume corresponding to the three-dimensional volume of the first simulated image;
training a machine-learning algorithm by providing the first simulated image as a sample artifact-prone image and providing the second simulated image as ground truth.

2. The method of claim 1, wherein the first segment of the central axis is centered on the first Z position.

3. The method of claim 1, wherein the digital phantom is reconstructed from a helical scan.

4. The method of claim 1, wherein the first simulated image is reconstructed using a three-dimensional filtered back projection process and wherein the two-dimensional images corresponding to axial slices of the digital phantom are each reconstructed using a two-dimensional filtered back projection process.

5. The method of claim 1, wherein the machine-learning algorithm is a three-dimensional convolutional neural network.

6. The method of claim 1, wherein each of the first simulated image and the second simulated image is split into three-dimensional patches, such that each patch of the first simulated image has a corresponding patch of the second simulated image, and wherein the three-dimensional patches are provided to the machine-learning algorithm.

7. The method of claim 6, wherein the machine-learning algorithm comprises at least one first convolutional step applied to each patch of the first simulated image provided followed by at least one down-sampling operation, and wherein at least one additional convolutional step is applied after down-sampling, and wherein the down-sampled patch is up-sampled after the at least one additional convolutional step, and wherein the up-sampled patch is concatenated with an output of the first convolutional step.

8. The method of claim 7, wherein the machine-learning algorithm is a three-dimensional U-net model, and each patch of the first simulated image is provided to the three-dimensional U-net model and the output is compared to the corresponding patch of the second simulated image.

9. The method of claim 8, wherein a mean square error between the output of the U-net model and the corresponding patch of the second simulated image is defined as a loss function for training the machine-learning algorithm.

10. The method of claim 8, wherein a forward pass through the U-net model comprises conversion of data to half precision and a following backward pass through the U-net model comprises loss scaling in half precision.

11. The method of claim 6, wherein prior to splitting the first simulated image into patches, the data corresponding to the first simulated image is normalized according to a sample mean and standard deviation calculated across a plurality of corrupted scans.

12. The method of claim 6, wherein the first simulated image and the second simulated image each comprise discrete photo, scatter, and combined image layers, and wherein each three-dimensional patch of the first simulated image and the second simulated image comprises corresponding discrete photo, scatter, and combined image layers, each provided to the machine-learning algorithm as discrete channels, each of which is processed with a discrete loss function, and wherein each channel is normalized independently of the other channels.

13. The method of claim 6, wherein each patch further comprises positional encoding, such that the machine-learning algorithm is provided with positional data associated with the corresponding patch.

14. The method of claim 1 further comprising incorporating an artifact causing feature into the three-dimensional digital phantom prior to selecting the first Z position.

15. The method of claim 1 further comprising:
selecting a second Z position along the central axis of the digital phantom;
simulating a second set of forward projections from the digital phantom taken along an axial trajectory at the second Z position along the central axis, the second set of forward projections having the first simulated collimation;
reconstructing a third simulated image from the second set of forward projections, the third simulated image being a three-dimensional volume encompassing a second segment of the central axis including the second Z position and different than the first segment of the central axis;
identifying a second plurality of secondary Z positions along the central axis other than the second Z position within the second segment of the central axis;
for each of the second plurality of secondary Z positions and the second Z position, simulating a second set of secondary forward projections from the digital phantom taken along an axial trajectory at the corresponding secondary Z position, the second set of secondary forward projections having the second simulated collimation;
reconstructing the forward projections associated with each of the second plurality of secondary Z positions and the second Z position into a two-dimensional image corresponding to an axial slice of the digital phantom at the corresponding Z position along the central axis;
combining the two-dimensional images to create a fourth simulated image comprising a three-dimensional volume corresponding to the three-dimensional volume of the third simulated image;
continuing to train the machine-learning algorithm by providing the third simulated image as a sample artifact-prone image and providing the fourth simulated image as ground truth.

16. The method of claim 15, wherein the first, second, third, and fourth simulated images are all provided to the machine-learning algorithm as a batch.

17. The method of claim 1, wherein the three-dimensional digital phantom varies along a time dimension, and wherein the first simulated image and the second simulated image are drawn from the digital phantom at a first time along the time dimension, the method further comprising:
simulating a second set of forward projections from the digital phantom at a second time along the time dimension taken along an axial trajectory at the first Z position, the second set of forward projections having the first simulated collimation;
reconstructing a third simulated image from the second set of forward projections, the third simulated image being a three-dimensional volume corresponding to the three-dimensional volume of the first simulated image;
for each of the first plurality of secondary Z positions and the first Z position, simulating a second set of secondary forward projections from the digital phantom at the second time along the time dimension taken along an axial trajectory at the corresponding secondary Z position, the second set of secondary forward projections having the second simulated collimation;
reconstructing the forward projections associated with each of the first plurality of secondary Z positions and the first Z position into a two-dimensional image corresponding to an axial slice of the digital phantom at the corresponding Z position along the central axis;
combining the two-dimensional images to create a fourth simulated image comprising a three-dimensional volume corresponding to the three-dimensional volume of the first simulated image;
continuing to train the machine-learning algorithm by providing the third simulated image as a sample artifact-prone image and providing the fourth simulated image as ground truth.

18. An artifact reduction method comprising:
performing the method of claim 1;
retrieving cone-beam computed tomography imaging data acquired using a cone-beam computed tomography process;
applying the trained machine-learning algorithm to the cone-beam computed tomography imaging data;
generating an artifact reduced image comprising a three-dimensional volume.
